(19) United States
(12) Patent Application Publication
(10) Pub. No.: US 2002/0107717 A1
(43) Pub. Date: Aug. 8, 2002

(54) System and method for consumer evaluations

(76) Inventors: Te-Kai Liu, Elmsford, NY (US); Paul Andrew Moskowitz, Yorktown Heights, NY (US); David Alvra Wood, Scarsdale, NY (US)

Correspondence Address: MCGINN & GIBB, PLLC, 8321 OLD COURTHOUSE ROAD, SUITE 200, VIENNA, VA, 22182-3817, US

(21) Appl. No.: 09/773,547

(22) Filed: Feb. 2, 2001

(51) Int. Cl. G06F 17/60

(52) U.S. Cl. 705/10; 705/14

(57) ABSTRACT

A system (and method) for conducting a survey, includes a presentation unit for presenting a plurality of choices at a point-of-transaction terminal, an input unit for entering the preferred choices, and a recording unit for recording the entered choices.

### BACKGROUND OF THE INVENTION

1. Field of the Invention

The present invention relates to a method and system for performing consumer evaluations, and more particularly to a method and system for performing consumer evaluations at a point-of-transaction (or point-of-sale).

2. Description of the Related Art

Information especially consumer preference information is a key component in making business or marketing decisions. However, people are reluctant to participate in such surveys. A simple method of getting consumer information and for rewarding consumers who participate in the survey is needed.

For example, finding a good restaurant in an area that is new to a consumer is not an easy task. A consumer who is away from home usually must rely on local information sources such as yellow pages or people who are familiar with the neighborhood. The information obtained from yellow pages is often not trustworthy and the information obtained from only one or two persons is often biased. Thus, a more reliable source of information which can suggest to consumers highly rated restaurants is very valuable. Such an information source can provide trustworthy and non-biased information if it can collect a large number of evaluations from consumers who have dining experience with the restaurants in the survey. Ideally, such a survey should be conducted at the point-of-sale. However, the information requested does not have to be limited to the quality of food. Political polls can be conducted at the point of sale (e.g., Press 1 for Candidate A, 2 for Candidate B, 3 for undecided). The point of sale may be any place where a credit card is used such as a supermarket, retail store, move ticket sales, hotel, restaurant, fuel dispensing machine (e.g., gas pump), etc.

### SUMMARY OF THE INVENTION

In view of the foregoing and other problems, disadvantages, and drawbacks of the conventional methods, an object of the present invention is to provide a system (and method) for making surveys easy for a consumer to participate in and such participation is garnered at the point-of-transaction or point-of-sale terminal.

In a first aspect of the present invention, a system (and method) for conducting a survey at a point-of-transaction terminal, includes a presentation unit for presenting a plurality of choices, an input unit for entering the preferred choices, and a recording unit for recording the entered choices.

In developing the present invention, the present inventors recognized that most consumers will be interested in participating in surveys only if there is an incentive such as a cash back bonus, frequent flyer miles, or the like. The survey should be short and easy to complete. A credit card company is advantageously positioned to collect consumers' evaluation, since it is involved in a large number of transactions. The credit card company may use its card readers (or point-of-sale terminals) to prompt consumers for satisfaction scores at the end of a transaction. The scale of the scores can be 2-level (e.g., such as satisfied or not satisfied) or 5-level (e.g., such as very satisfied, satisfied, neutral, unsatisfied, and very unsatisfied). The evaluation score will go to the credit card company. A consumer can also do the evaluation at the time of making a credit-card purchase on the Internet.

By using the information obtained, the credit card company can differentiate itself by providing information which can be used by consumers to make informed decisions, e.g., to select restaurants in an unfamiliar area. Good restaurants associated with the survey will benefit by having good ratings based upon survey results. Consumers benefit from finding good restaurants from the credit card company's recommendation list. The credit card company may also profit by selling the information obtained.

### BRIEF DESCRIPTION OF THE DRAWINGS

The foregoing and other objects, aspects and advantages will be better understood from the following detailed description of preferred embodiments of the invention with reference to the drawings, in which:

FIG. 1 illustrates a system 100 for consumer evaluations;

FIG. 2 illustrates a conventional method 200 for credit card transactions;

FIG. 3 illustrates a method 300 for credit card transactions and consumer evaluations;

FIG. 4 illustrates a system 400 for consumer evaluations associated with an automated teller machine (ATM) or a similar commercial transaction mechanism;

FIG. 5 illustrates an exemplary hardware/information handling system 500 for incorporating the present invention therein; and

FIG. 6 illustrates a signal bearing medium 600 (e.g., storage medium) for storing steps of a program of a method according to the present invention.

### DETAILED DESCRIPTION OF PREFERRED EMBODIMENTS OF THE INVENTION

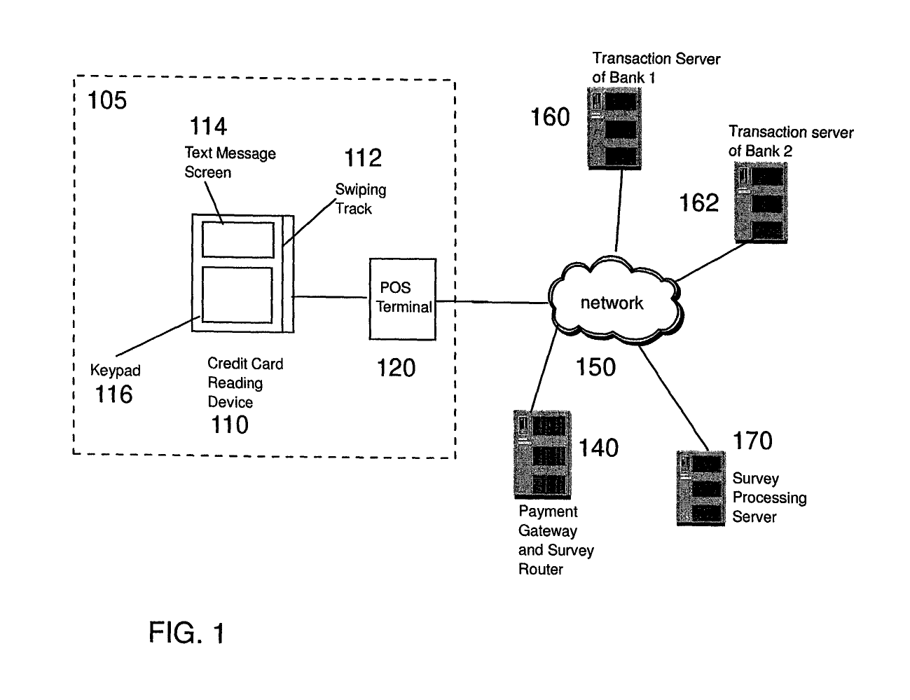

Referring now to FIGS. 1-6, a detailed description will be given of the embodiments of the present invention.

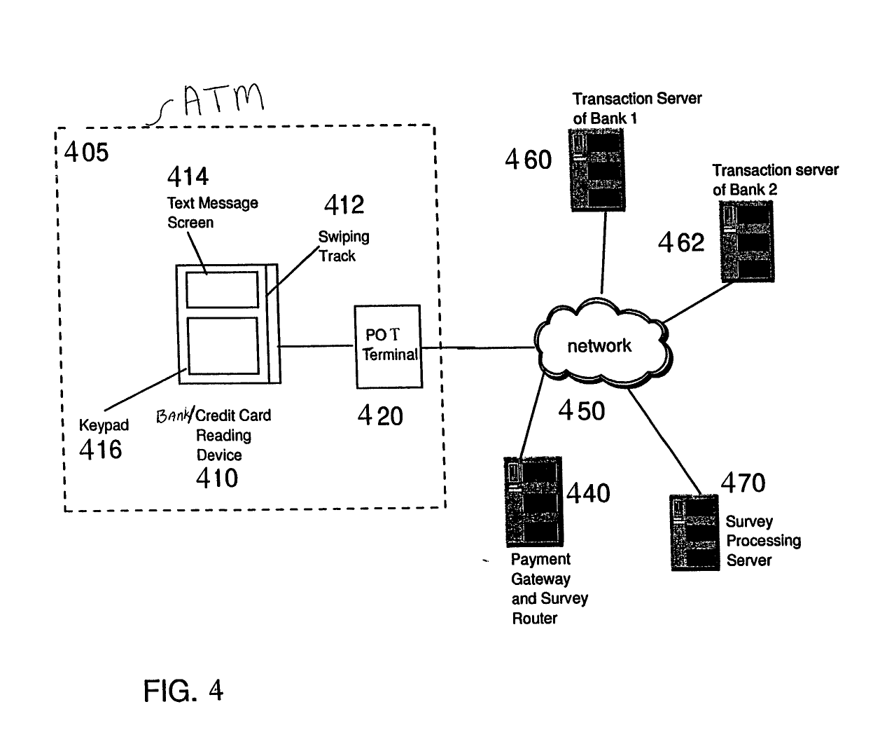

FIG. 1 illustrates a system 100 for consumer evaluations. A credit card reading device 110 is used with a point-of-sale (POS) terminal 120 (or in the case of other applications such as an automated teller machine as in FIG. 4, terminal 120 may be a point-of-transaction (POT) terminal 120). In this description, the POS terminal is a specialized variety of POT terminal. The devices shown may be connected electrically as shown, may be separate, or may be housed in one combined POS/Credit reading device 105 as outlined by the dotted line.

It is noted that, while a “credit card” reader (and a “credit card”) is discussed above and below for ease of understanding and the reader's clarity, as would be known by one of ordinary skill in the art taking the present application as a whole, “credit card” for purposes of the invention means any charge card, bank credit card, debit card, smart card, radio frequency identification transponder, wireless device (e.g., cell phone or wireless personal digital assistant) or any other device which can store identification information either thereon or remotely, etc. and which is capable of being presented for payment and being electronically read to authorize completion of a transaction.

In general, a credit card reading device will have a swiping track 112 for the reading of credit card information, a text display screen 114 for displaying the information and messages, and a keypad 116 as an additional input mechanism. The swiping track 112 allows credit card identification information to be read from the magnetic stripe of a credit card. This is a frequently used mode of reading credit card information. Although, FIG. 1 shows the magnetic stripe reader for reading card information, other methods may be used. These include manual entry of information, reading of information by the insertion of a chip-based smart card, and reading of information from a radio frequency identification transponder, and the like. Additionally, the combined POS/credit device 105 may be a computer terminal.

Credit card reading and POS devices are commonly found at restaurants, at the entrance to sports arenas or other entertainment locations, at hotels, and at most retail establishments. In the standard application of such devices, the information from a POS 120 is combined with credit information from a reader 110 and is then sent to a banking system payment gateway server or clearing house 140.

The connections are made by a network 150. The network 150 may be public or private switched telephone network (PSTN), an intranet, or the Internet. The payment gateway server orders the transfer of funds from the payer's bank, bank 1, by a transaction server 160 to the payee's bank, bank 2, using transaction server 162.

In the present invention, the payment gateway 140 has an added function. It is also a survey router, capable of routing survey questions originating from a survey processing server 170 over the network 150 to be displayed on the screen of the credit card reading device 110 or combined POS/credit device 105, and also routing the answers to survey questions received from the device 110 or 105 over the network 150 back to the survey processing server 170.

The survey processing server 170 originates and sends survey questions, receives and tabulates survey answers, and authorizes reward payments to the participants by instructing the payment gateway 140 to order the transfer of funds from a transaction server (e.g., server 162 of the payee's bank), or from another server connected to the network to the server of the bank of the payer (e.g., the consumer or participant), transaction server 160.

Although the awards for performing the survey may be monetary, other awards are possible. The survey processing server 140 may authorize the transfer of airline frequent flyer mile credits to the frequent flyer account of the payer or credits towards future purchases of the payer.

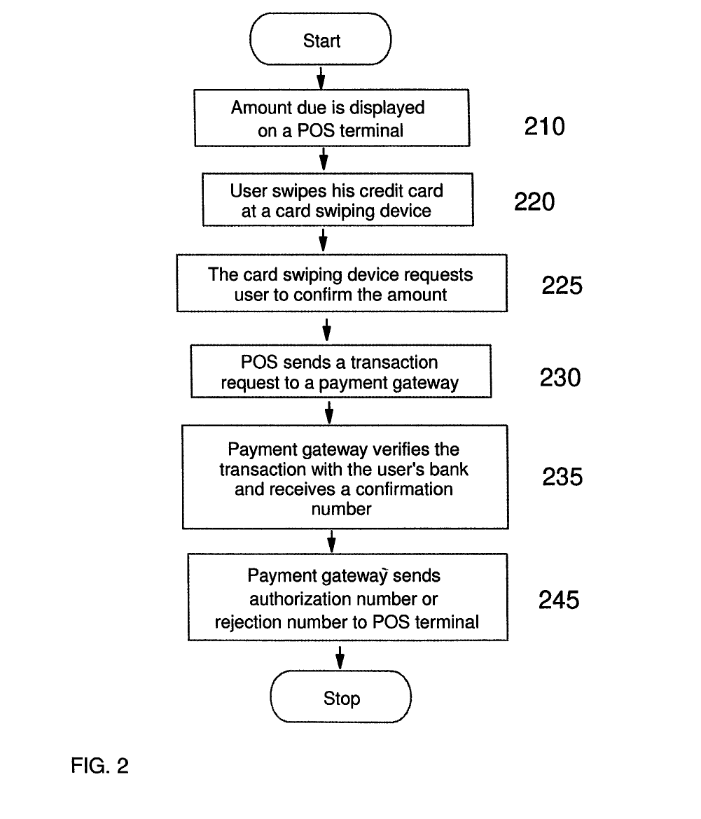

FIG. 2 illustrates a conventional method for credit card transactions, and provides a simplified schematic in steps 210-245 for a standard credit card transaction for which the card of the customer is valid and the credit of the customer is approved for the transaction. Although FIG. 2 applies to credit cards using the magnetic stripe as a mechanism for providing identification information, the same steps will also apply to other means of providing identification information such as manual entry, insertion of a chip-containing smart card, radio frequency identification, etc.

In the first step of the transaction 210, the amount due is displayed on the point-of-sale, POS terminal or combined POS/credit device, as described in FIG. 1.

Next, in step 220, the credit card of the user (the customer) is swiped through the card reader to read the card identification information.

In step 225, the card swiping device, or other type of card reader, then requests the user to confirm the amount of the transaction. In step 230, upon receiving positive confirmation, the combined POS/credit device, sends a transaction request to the payment gateway. The payment gateway verifies the transaction, orders the transfer of funds from the user's bank to the bank of the payee, and obtains an authorization or confirmation number, in step 235.

Finally, in step 245, the payment gateway sends an authorization number back to the POS device.

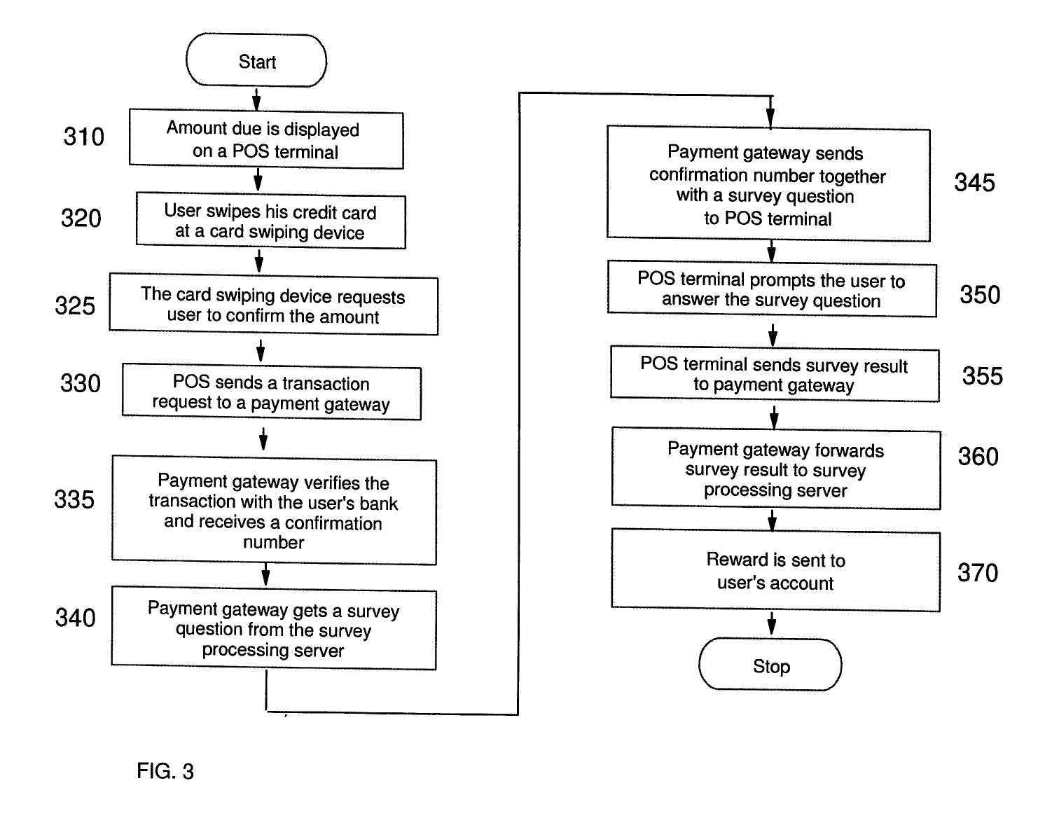

Turning now to FIG. 3, a flowchart is shown for conducting a survey along with processing a credit card transaction, according to the present invention. Steps 310, 320, 325, 330, and 335 of FIG. 3 are the same initial steps as are illustrated in steps 210, 220, 225, 230, and 235 of FIG. 2, respectively.

However, in the inventive process, in step 340, the payment gateway, which is now a payment gateway and survey router (e.g., reference numeral 140 of FIG. 1), obtains a survey question from the survey processing server. The payment gateway 140 now sends the confirmation number together with a survey question to the POS/credit device in step 345.

In step 350, the POS then prompts the user (customer) to answer the survey question.

In step 355, once an answer is entered, the POS terminal sends the result to the payment gateway/survey router.

The payment gateway/survey router forwards the result to the survey processing server in step 360.

Finally, in step 370, the survey processing server (e.g., reference numeral 170 in FIG. 1) authorizes reward payments to the customer by instructing the payment gateway to order the transfer of funds from a transaction server, The reward may also take the form of frequent flyer miles, discounts on future purchases, or the like.

FIG. 4 illustrates a system 400 (similar to that shown in FIG. 2) for consumer evaluations associated with an automated teller machine (ATM) or a similar commercial transaction mechanism. A chief difference between the ATM system of FIG. 4 and the system of FIG. 2 is that a point-of-transaction terminal 420 is provided instead of a point-of-sale terminal 120. Further, the transaction involves the deposit/disbursement of funds into a user's account and uses a bank card or a credit card. Other hardware and network computer are the same as those shown in FIG. 1.

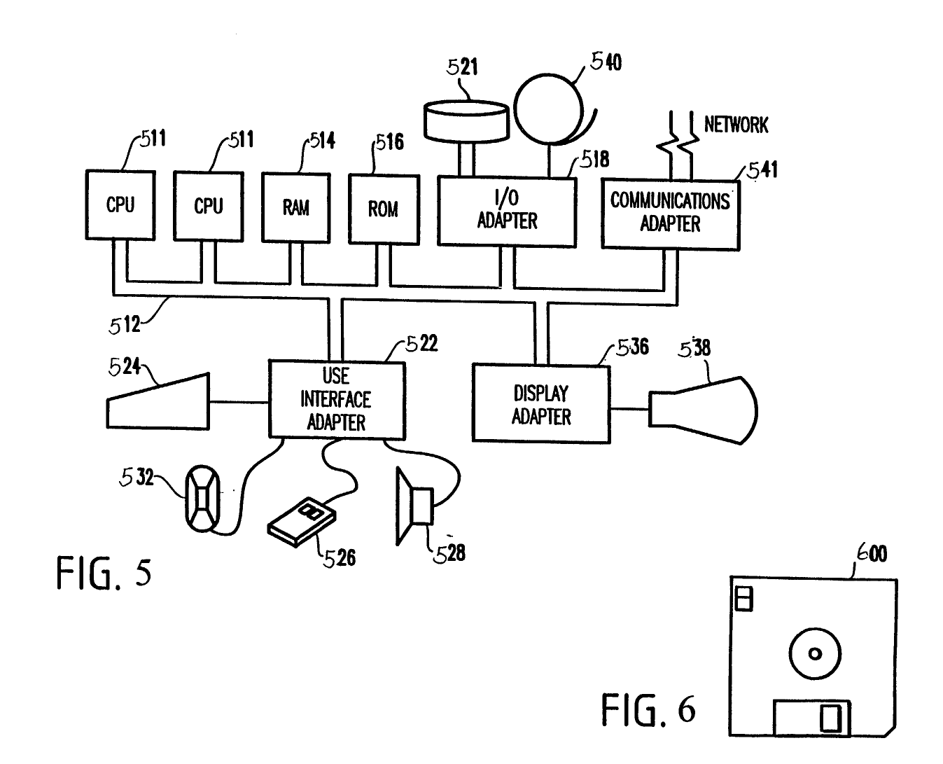

FIG. 5. illustrates a typical hardware configuration of an information handling/computer system in accordance with the invention and which preferably has at least one processor or central processing unit (CPU) 511. This configuration may be used to implement one or more of the servers 140, 160, 162, 170 shown in FIG. 1 or the equivalent servers shown in FIG. 4.

The CPUs 511 are interconnected via a system bus 512 to a random access memory (RAM) 514, read-only memory (ROM) 516, input/output (I/O) adapter 518 (for connecting peripheral devices such as disk units 521 and tape drives 540 to the bus 512), user interface adapter 522 (for connecting a keyboard 524, mouse 526, speaker 528, microphone 532, and/or other user interface device to the bus 512), a communication adapter 534 for connecting an information handling system to a data processing network, the Internet, an intranet, a personal area network (PAN), etc., and a display adapter 536 for connecting the bus 512 to a display device 538 and/or printer 539 (e.g., a digital printer or the like).

In addition to the hardware/software environment described above, a different aspect of the invention includes a computer-implemented method for performing the above method. As an example, this method may be implemented in the particular environment discussed above.

Such a method may be implemented, for example, by operating a computer, as embodied by a digital data processing apparatus, to execute a sequence of machine-readable instructions. These instructions may reside in various types of signal-bearing media.

Thus, this aspect of the present invention is directed to a programmed product, comprising signal-bearing media tangibly embodying a program of machine-readable instructions executable by a digital data processor incorporating the CPU 511 and hardware above, to perform the method of the invention.

This signal-bearing media may include, for example, a RAM contained within the CPU 511, as represented by the fast-access storage for example. Alternatively, the instructions may be contained in another signal-bearing media, such as a magnetic data storage diskette 600 (FIG. 6), directly or indirectly accessible by the CPU 511.

Whether contained in the diskette 600, the computer/CPU 511, or elsewhere, the instructions may be stored on a variety of machine-readable data storage media, such as DASD storage (e.g., a conventional “hard drive” or a RAID array), magnetic tape, electronic read-only memory (e.g., ROM, EPROM, or EEPROM), an optical storage device (e.g. CD-ROM, WORM, DVD, digital optical tape, etc.), paper “punch” cards, or other suitable signal-bearing media including transmission media such as digital and analog and communication links and wireless. In an illustrative embodiment of the invention, the machine-readable instructions may comprise software object code, compiled from a language such as “C”, etc.

With the invention, a system (and method) for making surveys easy for a consumer to participate in and such participation is garnered at the point-of-transaction or point-of-sale terminal.

Thus, the inventors have recognized that most consumers will be interested in participating in surveys only if there is an incentive such as a cash back bonus, frequent flyer miles, or the like. Further, the survey must be short and easy to fill out, and preferably should be at the point of sale or at the point of transaction terminal so as to use the existing infrastructure. That is, preferably the system is located where the product (or service) is delivered. As such, the system is preferably “in-situ”.

By using the information obtained, a company (e.g., a credit card company) can differentiate itself by providing information which can be used by consumers to select commodities (e.g., such as restaurants) in an unfamiliar area.

Further, the invention takes advantage of the existing infrastructure. Along these lines in the application of FIG. 1, credit information and survey information are returned to the vendor.

While the invention has been described in terms of preferred embodiments, those skilled in the art will recognize that the invention can be practiced with modification within the spirit and scope of the appended claims.

For example, the surveys can be any inquiries about a transaction and/or something related to the transaction. Alternatively, surveys may be about completely unrelated subject matter (e.g., “Which candidate will you vote for?”).

Additionally, the invention will find great benefit with a wide variety of applications. For example, a fuel (e.g. gasoline) station may employ a radio frequency identification transponder, such as a SpeedPass®, acting as a credit card with the good delivered being fuel or other items. The invention could be easily tailored for use with such a system and similarly the ATM application described above could use the same network and communication infrastructure for the transaction and the survey (e.g., simultaneously within the same transaction at the time of the transaction.)

What is claimed is:

1. A system for conducting a survey, comprising:
a presentation unit for presenting a plurality of choices at a point-of-transaction terminal;
an input unit for entering the preferred choices; and
a recording unit for recording the entered choices.

2. The system of claim 1, further comprising:
a reward unit for rewarding a user making the choices.

3. The system of claim 2, wherein said reward includes at least one of a monetary reward, a discount on a present purchase, a discount on a future purchase, and loyalty points for rewarding a frequent user.

4. The system of claim 1, wherein said survey evaluates consumer satisfaction with the transaction.

5. The system of claim 4, wherein said satisfaction is based upon at least one of the quality of a product and a quality of a service.

6. The system of claim 1, wherein said point-of-transaction comprises at least one of a restaurant, a hotel, a retail location, an automated teller machine (ATM), and an entertainment location.

7. The system of claim 1, wherein said survey comprises a political poll.

8. The system of claim 1, wherein said point-of-transaction terminal comprises a credit card reader.

9. The system of claim 1, wherein said point-of-transaction terminal comprises a point-of-sale terminal.

10. A system for conducting a consumer evaluation, comprising:
a credit card reader; and
a point-of-transaction (POT) terminal operatively coupled to said credit card reader, a survey being interactively and electronically displayed for said consumer at a time of a transaction.

11. The system of claim 10, wherein said credit card reader includes a swiping track for reading of credit card information, a text display screen for displaying the information and messages, and an input unit,
wherein said swiping track is for allowing credit card identification information to be read from a magnetic stripe of the credit card.

12. The system of claim 10, further comprising:
a payment gateway server operatively coupled to said point-of-transaction terminal; and
a survey processing center operatively coupled to said payment gate server.

13. The system of claim 12, wherein said payment gateway server is coupled to said point-of transaction terminal through a network.

14. The system of claim 13, wherein said network comprises one of a public switched telephone network (PSTN), an intranet, and the Internet.

15. The system of claim 12, wherein the payment gateway server orders a transfer of funds from a payer's bank, by a first transaction server to a payee's bank using a second transaction server.

16. The system of claim 12, wherein said credit card reader includes a display screen, and
wherein the payment gateway server includes a survey router, for routing survey questions originating from a survey processing server over a network to be displayed on the credit card reader, and routes answers to survey questions received from the credit card reader over the network to the survey processing server.

17. The system of claim 10, wherein said credit card reader and said POT terminal are integrally formed in a same housing.

18. The system of claim 12, wherein said survey processing server originates and sends survey questions, receives and tabulates survey answers, and authorizes reward payments to a user by instructing the payment gateway to order a transfer of funds from a transaction server, or from another server connected to the network to the server of the bank of the user.

19. The system of claim 10, wherein said system is usable with a retail establishment.

20. The system of claim 10, wherein said system is usable with an automatic teller machine (ATM).

21. The system of claim 10, wherein said system is usable with a commodity providing concern.

22. The system of claim 21, wherein said commodity providing concern comprises a fuel dispensing station.

23. A method of conducting a survey, comprising:
while performing a transaction at a point-of-transaction terminal, presenting a plurality of choices to a customer;
entering the preferred choices of the customer; and
recording the entered choices.

24. A credit card transaction method, comprising:
at a point-of-transaction (POT) terminal, reading a credit card of a customer by a card reader to read the card identification information;
requesting the customer to confirm an amount of the transaction;
upon receiving confirmation, sending a transaction request to a payment gateway, to verify the transaction, order a transfer of funds from the customer's bank to a bank of the payee, and obtain an authorization or confirmation number;
electronically obtaining, by the payment gateway, a survey question from a survey processing unit;
sending, by the payment gateway, an authorization number and the survey question to the POT terminal;
prompting the customer to answer the survey question;
once an answer is entered, sending the result to the payment gateway;
forwarding, by the payment gateway, a result to the survey processing server; and
authorizing, by the survey processing server, a reward to the customer.

25. The method of claim 24, wherein said authorizing by the survey processing server comprises instructing the payment gateway to order a transfer of funds from a transaction server, an award of frequent flyer miles, a discount on a future purchase, and a discount on a concurrent purchase.

26. A credit card transaction method, comprising:
at a point-of-transaction (POT) terminal, reading a credit card of a customer by a card reader to read the card identification information;
requesting the customer to confirm an amount of the transaction;
upon receiving confirmation, sending a transaction request to verify the transaction, order a transfer of funds from the customer's bank to a bank of the payee, and obtain an authorization or confirmation number;
electronically obtaining a survey question;
sending an authorization number and the survey question to the POT terminal;
prompting the customer to answer the survey question; and
once an answer is entered, sending the result to a survey processing server.

27. A commercial transaction and surveying system, comprising:
a presentation unit for presenting a plurality of choices;
an input unit for entering the preferred choices; and
a recording unit for recording the entered choices, said plurality of choices being presented at a point-of-transaction.

28. An automated teller machine (ATM), comprising:
a banking transaction system; and
a surveying system electronically linked to said banking transaction system such that at a point-of-transaction a survey is electronically presented to a customer.

29. The ATM of claim 28, wherein said surveying system comprises:
a presentation unit for presenting a plurality of choices;
an input unit for entering the preferred choices; and
a recording unit for recording the entered choices.

30. An automated teller machine (ATM), comprising:
a point-of-transaction terminal; and
a card reader electronically coupled to said point-of-transaction terminal, said card reader comprising a display screen, a customer input device and a mechanism for reading said card,
wherein substantially concurrently with said transaction, a survey is electronically received by said point-of-transaction terminal and displayed on said display screen for allowing said customer to participate in a survey.

31. A point-of-transaction device, comprising:
a point-of-transaction terminal; and
a credit card reader electronically coupled to said point-of-transaction terminal, said credit card reader comprising a display screen, a customer input device and a mechanism for reading said credit card,
wherein substantially concurrently with said transaction, a survey is electronically received by said point-of-transaction terminal and displayed on said display screen for allowing said customer to participate in a survey.

32. A signal-bearing medium tangibly embodying a program of machine-readable instructions executable by a digital processing apparatus to perform a method of conducting a survey, comprising:
while performing a transaction at a point-of-transaction terminal, presenting a plurality of choices to a customer;
entering the preferred choices of the customer; and
recording the entered choices.
